(19) United States
(12) Patent Application Publication
(10) Pub. No.: US 2010/0314551 A1
(43) Pub. Date: Dec. 16, 2010

(54) In-line Fluid Treatment by UV Radiation

(76) Inventors: Timothy J. Bettles, Rexford, NY (US); Steven Berger, Newburyport, NY (US); Sandra B. Schujman, Niskayuna, MA (US); Leo J. Schowalter, Latham, NY (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/813,293

(22) Filed: Jun. 10, 2010

Related U.S. Application Data
(60) Provisional application No. 61/186,203, filed on Jun. 11, 2009.

(51) Int. Cl. C02F 1/32

(52) U.S. Cl. 250/432 R; 250/492.1

(57) ABSTRACT

A UV source is regulated according to one or more purification parameters to produce a desired germicidal effect in a liquid while minimizing wasted power.

### RELATED APPLICATIONS

This application claims priority to and the benefit of, and incorporates herein by reference in its entirety, U.S. Provisional Patent Application No. 61/186,203, which was filed on Jun. 11, 2009.

### FIELD OF THE INVENTION

The present invention relates to the treatment of water and other fluids using ultraviolet (UV) radiation.

### BACKGROUND

Liquids, including water, are commonly used for many domestic and industrial purposes such as drinking, food preparation, manufacturing, processing of chemicals, and cleansing. Often it is necessary to purify a liquid prior to its use. Filters such as ceramic filters are typically used to remove particulate and chemical impurities from liquids. In addition, a liquid can be exposed to UV radiation to neutralize microorganisms and deleterious pathogens that may be present in the liquid. Exposure to short wavelength (e.g., 200 nm-320 nm) UV radiation can have a germicidal effect, i.e., the radiation can disrupt the DNA of many cellular microorganisms—thereby virtually destroying them or rendering them substantially harmless. The exposure to UV radiation can also substantially prohibit the growth and/or reproduction of microorganisms that may be present in the liquid.

Some known methods of purifying a liquid using UV radiation require the liquid to be stored in a container such as a small tank or a bottle. The liquid in the container is generally still or may flow at a slow rate due to actions such as a drip from a filter or sipping. A UV source such as a light-emitting diode (LED) or UV lamp radiates a predetermined amount of UV energy toward the liquid. After exposure to the UV energy for a pre-determined duration, the liquid in the container is considered purified. These purification systems, however, may not be effective when used to purify flowing liquids.

In many applications, the liquid used is not held steady in a container. Instead, it may flow at a high rate through various components of the application system such as chambers, filters, tubes, and pipes. Moreover, the flow rate of the liquid can change over time as the amount of liquid required by the application changes. The flow-rate change can also be unpredictable. Indeed, a component of the application may be replaced with a component of a different size or shape, causing the flow rate of the liquid to change. Finally, even when the flow rate of the liquid does not change substantially, the degree of contamination of the liquid may change, requiring a different level of UV radiation energy (i.e., target fluence) for effective purification of the liquid.

The germicidal effect of UV radiation on flowing liquid depends on the energy density of the UV radiation, i.e., the fluence of radiation, which in turn is related to the power of the radiation and the duration of exposure. The radiation power depends on the power supplied to the source of radiation, and the duration of exposure depends on the flow rate of the liquid. To illustrate, Table 1 shows the required power of a UV LED to purify water flowing at different rates and in tube of different sizes. The values shown in Table 1 assume that the flowing water would be exposed to UV radiation energy of approximately 40 mJ/cm², which is usually sufficient to substantially purify water. It can be seen from Table 1 that as the flow rate increases, greater LED power is required. Greater LED power is also required as the volume of the chamber in which the water is purified increases. The calculations in the table assume a water UV transparency at 254 nm wavelength of about 98% over a 10 cm distance. If the transparency is lower, either the LED power needs to be increased, the water flow decreased, or the length of the chamber adjusted so that the total dose received by the water contaminants is sufficient for purification. The values in Table 1 are offered only as an example, and it is understood that they are in no way constraining this invention to a certain geometry, flow rate, chamber dimensions or shape nor water quality.

TABLE 1

| | | Time for water to | |
|---|---|---|---|
| Flow rate | UV chamber | traverse 10 cm-long | Required UV LED |
| (l/min) | diameter (mm) | chamber | power (mW) |
| 0.5 | 6 | 0.34 | 33 |
| 1 | 6 | 0.17 | 67 |
| 3 | 10 | 0.16 | 200 |

Purification systems radiating a constant amount of energy may not produce a sufficient germicidal effect as the purification parameters (e.g., flow rate, target fluence, chamber dimensions, degree of contamination) change, requiring a greater amount of UV energy. On the other hand, in a purification system that radiates high amounts of UV energy when the system is turned on, a significant amount of power supplied to the system may be wasted. Thus, there is a need for improved systems and methods for purifying flowing liquids.

### SUMMARY OF THE INVENTION

In various embodiments of the present invention, a flowing liquid is exposed to UV radiation sufficient to have a desired germicidal effect, thereby substantially purifying the liquid while avoiding waste of energy consumed by the UV radiation source. This is achieved, in part, by using one or more purification parameters such as the target fluence, the dimensions of the purification chamber, and/or the flow rate of the fluid to determine the input power required by a UV source. By regulating the UV source according to the determined power, UV radiation sufficient to cause a germicidal effect, thereby substantially purifying the flowing liquid, can be produced. If the purification parameters change (e.g., the flow rate decreases) the updated parameters can be used to recalculate the power required by the UV source. Thus, by not having to produce the maximum UV radiation at all times excess UV radiation, and hence, excess power consumption by the UV source can be avoided while ensuring that the flowing liquid is substantially purified. The purification parameters can be provided to the purification system by a user. Alternatively, the system can include sensors to automatically determine some purification parameters. As used herein, the term “substantially” generally means±10%, and in some embodiments, ±5%.

Accordingly, in one aspect, the invention relates to method of germicidally treating a flowing fluid. In various embodiments, the method comprises the steps of obtaining one or more purification parameters associated with flow of the fluid, and based on the parameter(s), exposing the flowing fluid to UV radiation at a target fluence sufficient to achieve a desired germicidal effect in the fluid. The exposing step may comprise determining, based on the parameter(s), the intensity of UV radiation sufficient to achieve the target fluence, and regulating a UV radiation source in response to the determined intensity. For example, the target fluence may be minimally sufficient to achieve the desired germicidal effect.

In various embodiments, the exposing step is accomplished using at least one LED radiating into the flowing fluid. Proper exposure may be achieved in various ways. In one approach, the power level of the LED(s) is adjusted. Alternatively, the exposing step may be accomplished using a plurality of LEDs radiating into the flowing fluid, and proper exposure is achieved by activating a sufficient number of the LEDs.

The purification parameter may be one or more of the fluid flow rate, the target fluence, an exposure time, and/or at least one dimension of a chamber through which the fluid flows. The parameter(s) may be obtained via a user interface, and/or may involve sensing the fluid flow rate using a sensor.

In another aspect, the invention relates to a system for germicidally treating a flowing fluid. In various embodiments, the system comprises a source of UV radiation directed into the flow; a computation unit for determining, based on at least one flow parameter, a configuration of the UV source to achieve a desired germicidal effect in the fluid; and a mechanism for controlling the UV source in response to the determined configuration. The configuration of the UV source may be determined, for example, by computing a UV intensity sufficient to achieve a desired germicidal effect in the fluid. The system may contain a mechanism, such as a user interface (e.g., touch pad) for obtaining the flow parameter(s). The flow parameter(s) may be or include the flow rate, in which case the mechanism for obtaining the flow rate may be a flow sensor—e.g., a time-of-flight sensor and/or a pressure sensor.

The UV source may comprise at least one UV LED oriented to radiate into the flowing fluid. In various embodiments, the controlling mechanism adjusts a power level of the UV LED(s), which may, for example, be positioned on an interior wall of a chamber through which the fluid flows or within flow path of the fluid. The UV LED(s) may be sealed by a UV-transparent material. In some embodiments, the source of UV radiation comprises a plurality of LEDs, the configuration comprises a group of LEDs to be activated, and the controlling mechanism activates the LEDs in the group. The configuration may further comprise a power level of each LED in the group, in which case the controlling mechanism may adjust the power supplied to each LED in the group.

In some embodiments, the system includes a sensor for sensing fluid flow and a switching mechanism, responsive to the sensor, for activating the UV source only when fluid flow is sensed.

### LIST OF FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 schematically shows a representative purification system according to the present invention.

FIG. 2 schematically shows a purification system having a user interface to obtain purification parameters.

FIGS. 3A and 3B schematically show a purification system using a pressure sensor to determine the flow rate of the liquid.

FIGS. 4A and 4B schematically show a purification system using a time-of-flight flow-determination module to determine the flow rate of the liquid.

FIG. 5 shows the steps of an embodiment of a method of purifying liquid according to the present invention.

### DETAILED DESCRIPTION

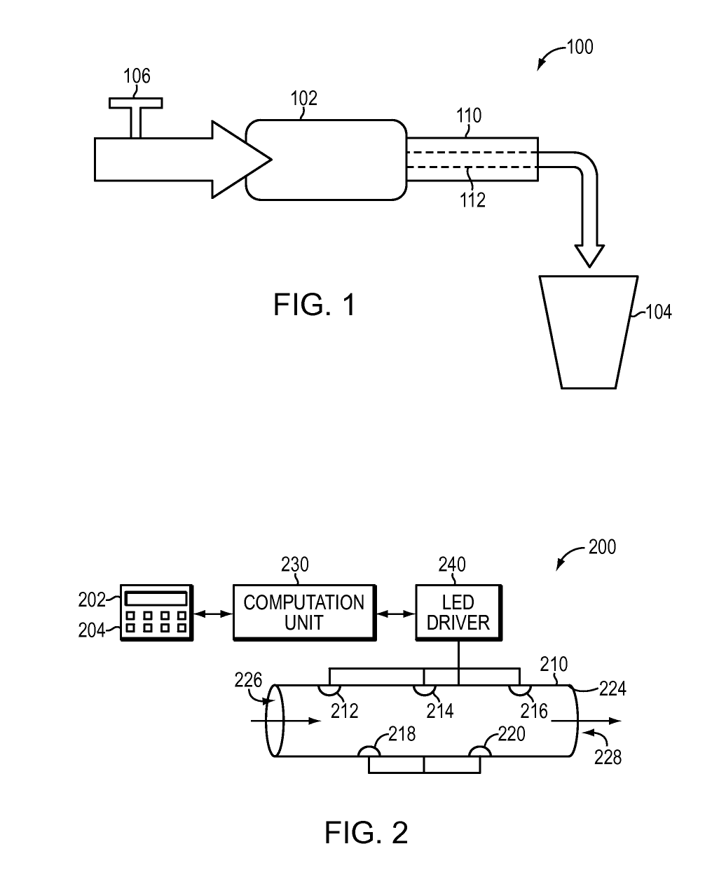

With reference to the representative application system 100 shown in FIG. 1, liquid initially flows into a conventional filter 102 (e.g., a ceramic filter) where particulate and chemical impurities in the liquid are substantially removed. This filter also ensures that the water is sufficiently transparent for the UV radiation to have the desired effect. The filtered liquid then flows into a chamber 112 of the purification system 110. In the chamber 112 the liquid is exposed to UV light, thereby substantially neutralizing the microorganisms that may be present in the liquid. The liquid is thus substantially purified, and flows into a receptacle 104 whereupon it may be used for various purposes such as drinking, food and chemical processing, manufacturing, and cleansing. The structure and operation of various embodiments of the purification system 110 is described below with reference to FIGS. 1-5.

Depending upon a desired rate of flow of the purified liquid, a valve 106 can be adjusted to regulate the flow of the liquid into the conventional filter 102 and the purification system 110. As explained below, the purification system 110 uses the liquid's flow rate and other parameters to adjust the UV radiation to which the liquid is exposed.

FIG. 2 shows a purification system 200 in which the purification parameters are supplied by a user via a user interface 202, i.e., a touch-pad keyboard 204 in this embodiment. It should be understood, however, that other devices (e.g., wired or wireless receivers, infrared receivers) may also be used as a user interface 202. Through the touch-pad keyboard 204 the user can enter values for parameters such as the flow rate, dimensions of the purification chamber (such as the length and diameter of the chamber), the target fluence, and/or the degree of contamination of the liquid. In other embodiments, as described below, one or more parameters (such as the flow rate) are determined automatically by a sensor arrangement.

The purification system 200 also includes a purification chamber 210 containing five UV LEDs 212, 214, 216, 218, 220 affixed to the inner surface 224 of the chamber 210. The UV LEDs 212, 214, 216, 218, 220 are oriented to provide UV radiation to the liquid flowing through the chamber 210. Although FIG. 2 shows five LEDs, other embodiments may use fewer (i.e., as few as only one) or more LEDs, and configurations using fewer or more LEDs are within the scope of the present invention.

The parameters input through the touch-pad keyboard 204 are received by a computation unit 230. If the degree of contamination of the liquid is provided, the computation unit 230 can determine the target fluence, i.e., the fluence required to substantially purify the liquid. Alternatively, as described above, the target fluence can be directly supplied by the user. The liquid entering through the inlet 226 and exiting through the outlet 228 of the chamber 210 is exposed to UV radiation from the UV LEDs 212, 214, 216, 218, 220 for the duration of time it takes the liquid to pass through the chamber 210. The computation unit 230 computes the average passage time using the (sensed or user-provided) flow rate and the dimensions of the chamber 210. Based on the target fluence (computed or supplied as described above) and the time for which the liquid should be exposed to UV radiation from UV LEDs 212, 214, 216, 218, 220 (i.e., the average passage time), the computation unit 230 determines the intensity of UV radiation from the LEDs 212, 214, 216, 218, 220 required to cause an adequate germicidal effect on the liquid flowing through the chamber 210.

The intensity of light and/or UV radiation emitted from an LED depends on the current flowing through the LED, and is thus related to the power supplied to the LED. Therefore, the computation unit 230 can also determine total power that must be delivered to the LEDs to provide the required radiation intensity. An LED driver 240 can supply the determined power (i.e., current) to the various LEDs. All LEDs may receive the same amount of power, or different LEDs may receive different amounts of power. In addition, the driver may choose to turn on only some LEDs (e.g., LEDs 212, 220) and may choose to turn off the other LEDs 214, 216, 218 in order to achieve the target fluence.

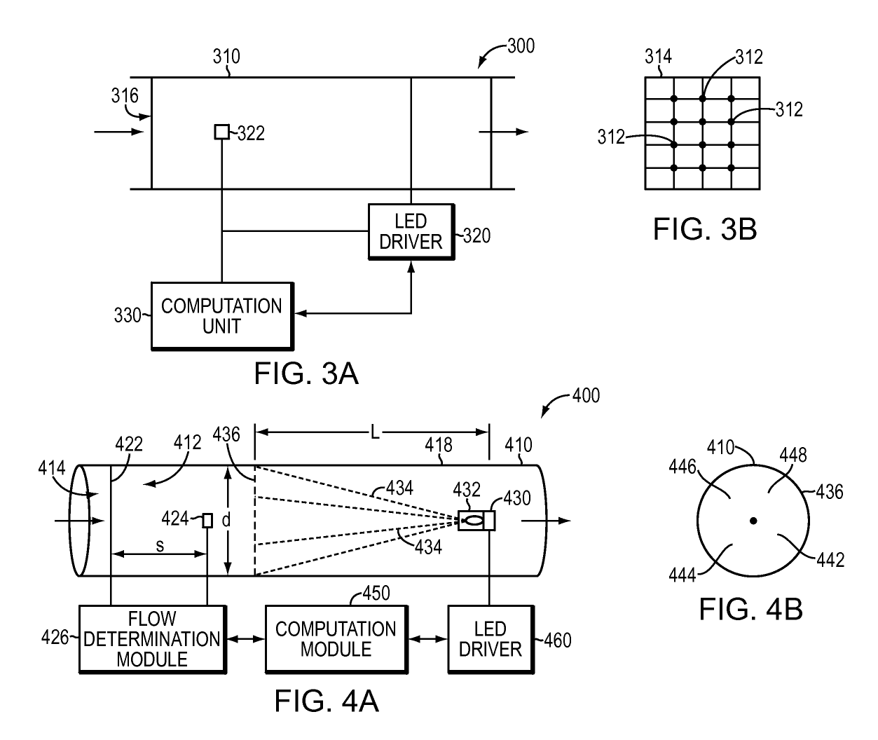

In the purification system 300 illustrated in FIGS. 3A and 3B, the chamber 310 in which purification of the flowing liquid occurs has a rectangular shape. The UV LEDs 312 are arranged on a grid 314, and the power supplied to each UV LED 312 is controlled by a driver 320. The system also includes a pressure sensor 322 positioned near the liquid inlet 316 of the chamber 310 to measure the pressure of the flowing liquid. The computation unit 330 receives a signal from the pressure sensor 322 and measures the liquid pressure in response thereto. The computation unit 330 then uses the measured pressure and other purification parameters (such as the dimensions of the chamber 310) to determine the flow rate of the liquid. For such determinations, it is assumed that the type of liquid flow (e.g., laminar flow) involves a known relationship between pressure and flow rate. The other purification parameters can be stored in a memory (not shown) included in the computation unit 330. Alternatively or in addition, the other purification parameters can be provided to the computation unit 330 via a user interface.

Using the determined flow rate of the liquid and the other parameters, the computation unit 330 determines the power that must be supplied to each LED 312 in the grid 314 so as to substantially purify the liquid, as described above with reference to FIG. 2. The system 300 includes an “instant-on” feature in which the pressure sensor 322, acting as a switch, directly controls the driver 320 and causes it to switch off all LEDs 312 when no pressure (i.e., flow) is detected. When a flow is detected, the sensor 322 allows the driver 320 to regulate the LEDs, which the driver 320 does in the grid 314 according to the computed power. The instant-on feature can decrease power consumption and unnecessary use of the LEDs 312.

Another system and method of determining the flow rate of a liquid is illustrated with reference to FIGS. 4A and 4B. The purification system 400 includes a circular chamber 410. A heating coil 422 is affixed to the inner surface 412 of the chamber 410 near the liquid inlet 414. A temperature sensor 424 positioned downstream from the heating coil at a known distance, denoted as “s.” A flow-determination module 426 applies a heat pulse to the coil 422 at a known time. A portion of the flowing liquid near the coil 422 at that time becomes heated, and after a certain duration, the leading edge of the heated portion of the liquid reaches the temperature sensor 424. The temperature sensor 424 detects a change in temperature at a certain time after the time at which the flow-determination module 426 applies the heat pulse. As the heat pulse is carried by the flowing liquid from the coil 422 to the sensor 424, the time of flight (i.e., the time elapsed between the application of the heat pulse and subsequent detection of its leading edge) is related to the flow rate of the liquid.

The purification system shown in FIGS. 4A and 4B includes one UV LED 430. The UV LED 430 is positioned in the path of the flowing liquid. In order to protect the UV LED 430 from damage due to the flowing liquid, the UV LED 430 is hermetically sealed. Certain materials used to hermetically seal LEDs that output light in the visible spectrum may not be suitable for sealing the UV LED 430 if they are not transparent to the UV radiation in a wavelength range (e.g. 200 nm-320 nm) in which the radiation can have germicidal effect. The UV LED 430 is therefore sealed using a fluoropolymer, e.g., TEFLON AF 432 (supplied by du Pont). The UV LED 430 can also be sealed using other UV-transparent materials such as a UV-transparent glass or another UV-transparent fluoropolymer.

The UV LED 430 desirably has a high wall-plug efficiency, i.e., the fraction of the total electric power delivered to the UV LED 430 that is converted into UV radiation is greater than 10%. The UV LED 430 also has an operating lifetime of approximately 5,000 hours. Such UV LEDs can be constructed by growing pseudomorphic layers of AlₓGa₁₋ₓN on AlN single-crystal substrates as described, for example, in U.S. patent application Ser. No. 12/020,006, filed on Jan. 25, 2008. High-efficiency UV LEDs are described in U.S. patent application Ser. Ser. No. 10/910,162, filed on Aug. 3, 2004. These applications are incorporated herein by reference in their entireties.

As the UV LED 430 has a long life and because it is hermetically sealed, it may have to be replaced less frequently than UV LEDs in other applications. Due to the relatively high efficiency of the UV LED 430, the cost of operating the purification system 400 may also be relatively small. It should be understood, however, that high efficiency, long life, and hermetic sealing are not essential features of the present invention, and that UV LEDs not having one or more of these properties (e.g., an unsealed UV LED having a wall-plug efficiency less than 10% (e.g., 2%) and a relatively short lifetime (e.g., 2,000 hours)) can also be used.

The UV LED 430 has a Lambertian output profile, i.e., the energy density of the UV radiation 434 emitted by the LED is substantially uniform across the cross-sectional area 436 of diameter d at a distance L from the LED. As a result, liquid flowing through various locations 442, 444, 446, 448 in the cross-section 436 is exposed to approximately the same intensity of UV radiation or fluence. Again, a Lambertian output profile is a beneficial but not an essential feature, and UV LEDs having non-uniform output profiles can also be used in other embodiments of the present invention.

As described above, the computation unit 450 determines the power required by the UV LED 430 to produce fluence having adequate germicidal effect within the portion 418 of length L of the chamber 410. The computation unit 450 can be configured to determine a minimum required power such that the produced fluence is minimally sufficient. The driver 460 regulates the UV LED 430 according to the computed power.

Although the system 400 uses one UV LED 430, it should be understood that other configurations of UV LEDs such as LEDs affixed to the inner surface of the chamber 410 or affixed, for example, to a circular grid inside the chamber 410 are also within the scope of the invention. As explained with reference to FIG. 2, the driver 460 can regulate the several LEDs in these configurations.

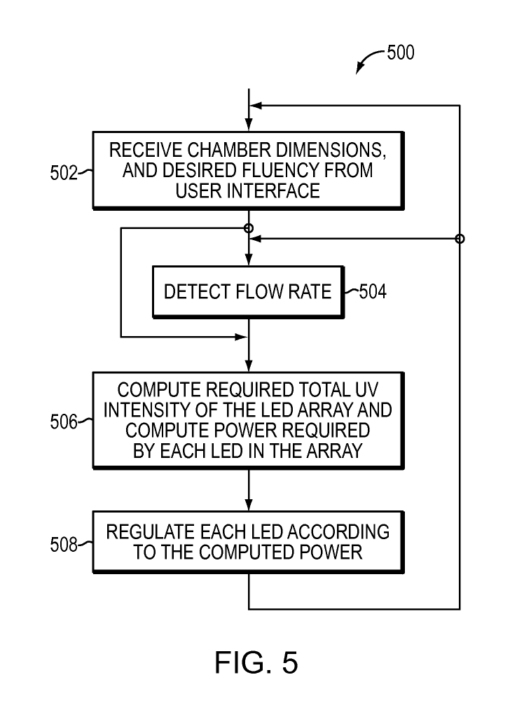

FIG. 5 shows the steps of purifying a flowing liquid according to one embodiment of the present invention. In step 502 the dimensions of the purification chamber and the target fluence are received via a user interface. Other purification parameters may also be received in step 502. In step 504, the flow rate of the liquid is determined. Step 504 can be skipped if the flow rate was received in step 502. In step 506 the total UV intensity required from the LEDs in an array to cause a sufficient germicidal effect on the flowing liquid is computed. The power required by each LED is also computed in step 506 based on the required UV intensity. Each LED is then regulated according to the computed power in step 508. Steps 504 through 508 are repeated to detect a change in the flow rate and to accordingly adjust the power supplied to the LEDs. In addition, step 502 can also be repeated. By adjusting the power supplied to the LEDs according to changes in the flow rate or other purification parameters, the power wasted by a purification system can be minimized while ensuring that UV radiation sufficient to substantially purify the liquid is delivered.

According to one embodiment of the invention, a safety mechanism is added that acts if not enough UV radiation is provided in order to achieve purification. The safety mechanism comprises, for example, a UV detector that measures the output UV power and compares it against the UV power needed according to the purification parameters. If the measured UV power is lower than that determined as needed by the system, a safety shut-off lock and/or an alarm is activated.

Although the present invention has been described with reference to specific details, it is not intended that such details should be regarded as limitations upon the scope of the invention, except as and to the extent that they are included in the accompanying claims.

What is claimed is:

1. A method of germicidally treating a flowing fluid, the method comprising the steps of:
obtaining at least one purification parameter associated with flow of the fluid; and
based on the at least one obtained parameter, exposing the flowing fluid to UV radiation at a target fluence sufficient to achieve a desired germicidal effect in the fluid.

2. The method of claim 1, wherein the exposing step comprises:
determining, based on the at least one obtained parameter, an intensity of UV radiation sufficient to achieve the target fluence; and
regulating a UV radiation source in response to the determined intensity.

3. The method of claim 1, wherein the target fluence is minimally sufficient to achieve the desired germicidal effect.

4. The method of claim 1, wherein the exposing step is accomplished using at least one LED radiating into the flowing fluid.

5. The method of claim 4, wherein the exposing step comprises adjusting a power level of the at least one LED.

6. The method of claim 1, wherein the exposing step (i) is accomplished using a plurality of LEDs radiating into the flowing fluid, and (ii) comprises activating a sufficient number of the LEDs.

7. The method of claim 1, wherein the at least one parameter is selected from the group consisting of a fluid flow rate, the target fluence, an exposure time, and at least one dimension of a chamber through which the fluid flows.

8. The method of claim 1, wherein the obtaining step comprises receiving the at least one parameter via a user interface.

9. The method of claim 1, wherein the obtaining step comprises sensing a fluid flow rate by a sensor.

10. A system for germicidally treating a flowing fluid, the system comprising:
a source of UV radiation directed into the flow;
a computation unit for determining, based on at least one flow parameter, a configuration of the UV source to achieve a desired germicidal effect in the fluid; and
a mechanism for controlling the UV source in response to the determined configuration.

11. The system of claim 10, wherein determining a configuration of the UV source comprises computing a UV intensity sufficient to achieve a desired germicidal effect in the fluid.

12. The system of claim 10, further comprising a mechanism for obtaining the at least one flow parameter.

13. The system of claim 12, wherein the mechanism for obtaining the at least one parameter is a user interface.

14. The system of claim 13, wherein the user interface is a touch pad.

15. The system of claim 12, wherein (i) the at least one parameter comprises a flow rate, and (ii) the mechanism for obtaining the flow rate comprises a flow sensor.

16. The system of claim 15, wherein the flow sensor is a time-of-flight sensor.

17. The system of claim 15, the flow sensor comprises a pressure sensor.

18. The system of claim 10, wherein the UV source comprises at least one UV LED oriented to radiate into the flowing fluid.

19. The system of claim 18, wherein the controlling mechanism adjusts a power level of the at least one UV LED.

20. The system of claim 18, wherein the at least one UV LED is positioned on an interior wall of a chamber through which the fluid flows.

21. The system of claim 18, wherein the at least one UV LED is positioned within flow path of the fluid.

22. The system of claim 18, wherein the at least one UV LED is sealed by a UV-transparent material.

23. The system of claim 10, wherein (i) the source of UV radiation comprises a plurality of LEDs, (ii) the configuration comprises a group of LEDs to be activated, and (iii) the controlling mechanism activates the LEDs in the group.

24. The system of claim 23, wherein (i) the configuration further comprises a power level of each LED in the group, and (ii) the controlling mechanism adjusts power supplied to each LED in the group.

25. The system of claim 10 further comprising:
a sensor for sensing flow of a fluid; and
a switching mechanism, responsive to the sensor, for activating the UV source only when fluid flow is sensed.
